(19) United States
(12) Patent Application Publication
(10) Pub. No.: US 2025/0298709 A1
(43) Pub. Date: Sep. 25, 2025

(54) FAULT INJECTION BASED ON CONTEXT INFORMATION

(71) Applicant: Oracle International Corporation, Redwood Shores, CA (US)

(72) Inventors: Rahul Singh, Panipat (IN); Salim Achouche, Chapel Hill, NC (US)

(73) Assignee: Oracle International Corporation, Redwood Shores, CA (US)

(21) Appl. No.: 18/609,617

(22) Filed: Mar. 19, 2024

(51) Int. Cl. G06F 11/263

(52) U.S. Cl. CPC G06F 11/263

(57) ABSTRACT

A method can include intercepting a call invoked by a component-being-tested (CBT). The method can include determining context information for the call. The context information including information identifying a fault location associated with the call and information identifying arguments for the call. The method can include performing processing to determine whether to inject a fault at the fault location associated with the call, the processing comprising determining if a fault is to be injected for the call and the context information. The method can include, in response to determining that a fault is to be injected, identifying a particular fault to be injected and injecting the particular fault at the fault location during execution of the CBT. The method can include, in response to determining that a fault is not to be injected for the call, invoking a library implementation corresponding to the call during execution of the CBT.

### BACKGROUND

Modern software architectures may be designed to address the challenges of scalability, agility, ease of use, cost-effectiveness, and integration capabilities. These systems are typically very complex, as they rely on many interconnected components and services to implement the underlying infrastructure, applications, and services. This complexity makes these systems prone to failures. Additionally, the testing resiliency and reliability of these systems becomes increasingly challenging. The system complexity increases even more in a cloud-based execution environment, where the system may include a large number of microservices.

Testing frameworks are typically used to test software systems, for example, by injection faults into a software system or component being tested and determining the response of the system or component. Existing testing frameworks are however limited in their fault injection capabilities. With existing fault-injection frameworks, it is hard to inject faults or failures at places within the system being tested where they can actually happen in a production environment. For example, most of the existing frameworks use static fault-injection such as compile-time injection. The existing frameworks are also quite limited in the type of faults that are injected. For example, existing frameworks are configured to introduce random, low-level faults, mostly network-level faults. The randomness limits the effectiveness of such systems since the tester has very little control over where the faults are injected and the nature of the faults. Existing testing systems are also limited in the manner in which the tests are managed. Often times, the existing frameworks inject faults in the same code path again and again, as the framework is not aware of any context, while some other code paths may never be tested. Thus, testing and validating the actual application logic becomes really hard and impractical with the existing frameworks.

### BRIEF SUMMARY

The present disclosure relates generally to a fault injection system, or a framework, that can dynamically inject faults in a controlled, context-aware, and flexible manner. The fault injection system can inject faults at fault points or locations in complex systems such that a behavior of the system being tested in a real world scenario or environment, such as a testing environment, a production environment, etc., can be represented.

Various embodiments are described herein to illustrate various features. These embodiments include various methods, systems, non-transitory computer-readable storage media storing programs, code, or instructions executable by one or more processors, and the like. Some embodiments may be implemented by using a computer program product, comprising computer program/instructions which, when executed by a processor, cause the processor to perform any of the methods described in the disclosure.

In certain embodiments, a method can be used to dynamically inject a fault based on context information. The method can include intercepting a call invoked by a component-being-tested (CBT). The method can include determining context information for the call. The context information can include information identifying a fault location associated with the call and information identifying any arguments for the call. The method can include performing processing to determine whether to inject a fault at the fault location associated with the call. The processing can include, based on historical fault injection data stored for the CBT and the context information determined for the call, determining if a fault is to be injected for the call and the context information. The historical fault injection data can be stored for the CBT including data for previously injected faults for the CBT and historical context information for the previously injected faults. The method can include, in response to determining that a fault is to be injected, identifying a particular fault to be injected and injecting the particular fault at the fault location during execution of the CBT. The method can include, in response to determining that a fault is not to be injected for the call, invoking a library implementation corresponding to the call during execution of the CBT.

In certain examples, the context information can identify a function or a workflow that caused the call to be invoked.

In certain examples, (i) performing processing to determine whether to inject the fault can include selecting a particular fault to be injected based upon the historical fault injection data for a combination of the call and associated particular context and (ii) injecting the fault at the fault location during execution of the CBT can include injecting the selected particular fault into the CBT by providing the selected particular fault to the CBT as a response to the call.

In certain examples, selecting the particular fault can include (i) determining, based upon the historical fault injection data, a particular type of fault that has not been previously injected for the combination, and (ii) selecting the particular fault for injection to be of the particular type of fault.

In certain examples, selecting the particular fault can include selecting a default fault type or a customized fault type, and the customized fault type can be specified using configuration information provided to a computing system.

In certain examples, (i) intercepting the call from the CBT can be performed by a dynamic proxy handler of the computing system that is configured to intercept the call, obtain the context information, and inject the selected particular fault into the CBT, and (ii) determining whether the fault is to be injected can be performed by a fault driver of the computing system that is configured to select the particular fault for injection into the CBT.

In certain examples, determining whether the fault is to be injected can include determining whether to inject multiple faults sequentially or at least partially in parallel.

The foregoing, together with other features and embodiments will become more apparent upon referring to the following specification, claims, and accompanying drawings.

### BRIEF DESCRIPTION OF DRAWINGS

To easily identify the discussion of any particular element or act, the most significant digit or digits in a reference number refer to the figure number in which that element is first introduced.

FIG. 1 is a block diagram of a computing environment including a fault injection system that can be used to inject faults based on context information, according to at least one embodiment.

FIG. 2 is a flowchart of a process to determine whether to inject a fault for a component being tested, according to at least one embodiment.

FIG. 3 is a flowchart of a process to select and inject a particular fault, according to at least one embodiment.

FIG. 4 is a swim-lane diagram representing a process for determining whether to inject a fault for a component being tested, according to at least one embodiment.

FIG. 5 is a block diagram illustrating one pattern for implementing a cloud infrastructure as a service system, according to at least one embodiment.

FIG. 6 is a block diagram illustrating another pattern for implementing a cloud infrastructure as a service system, according to at least one embodiment.

FIG. 7 is a block diagram illustrating another pattern for implementing a cloud infrastructure as a service system, according to at least one embodiment.

FIG. 8 is a block diagram illustrating another pattern for implementing a cloud infrastructure as a service system, according to at least one embodiment.

FIG. 9 is a block diagram illustrating an example computer system, according to at least one embodiment.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

The present disclosure relates generally to a fault injection system, or a framework, that can dynamically inject faults, for example into a software component being tested, in a controlled, context-aware, and flexible manner. The fault injection system can inject faults at fault points or locations in complex software systems such that a behavior of a system being tested in a real world scenario or environment, a testing environment, a production environment, etc., can be represented. The system being tested, which can be a software system, can correspond to an application or a collection of applications and microservices, and the system being tested can include one or more components. A component being tested (CBT) is a component included in the system being tested in which the CBT is to be tested. The fault injection system can provide a context-aware, modular, scalable, complete, and configurable approach to introduce faults in modern software systems in a controlled manner. The fault injection system can discover new fault points, can learn with multiple iterations of code execution, can schedule different faults to inject for future runs, and can provide configuration information that can be used to customize fault injection behavior such as to override default faults for fault points. The fault injection system can be used to run tests in an emulated environment without interacting with real, dependent services. The fault injection system can introduce faults concurrently in parallelly running processes, which can facilitate identifying potential issues, test resiliency, and fault tolerance in modern, scalable systems.

The fault injection system can be context-aware, which may involve receiving and using context information, such as information identifying a fault location associated with the call and information identifying any arguments for the call. Using the context information can involve making decisions, such as whether to inject a fault, where to injection the fault, which fault to select, and the like, based upon the context information.

The fault injection system can be modular, flexible, scalable, and the like. For example, the fault injection system can be customized to a user preference and/or can be used on system environments of differing sizes. The modular nature of the fault injection system can allow the fault injection system to use different types of faults to test the system environment, to test different types of components, such as process handlers, etc., and the like. Additionally, the modular nature of the fault injection system can allow the fault injection system to determine whether to inject faults or to simply return library implementations of a call to ensure that system environments of any size are sufficiently tested.

The fault injection system can be complete such that testing on the system environment performed by the fault injection system can track and test each possible fault and/or each possible fault location for each possible component that can be tested. For example, the fault injection system can include a data store or other suitable repository that can be used to track and/or access historical fault injection data for the system environment. The fault injection system can access the data store to determine whether to inject a fault and, if so, which fault to inject for each component being test and for each potential location for a fault to be injected.

The fault injection system can involve techniques of testing software that deliberately introduce errors, or faults, in a system being tested, or components thereof, to check if the system, or the components, can withstand the error and properly respond to or recover from the error. If the system being tested includes multiple components, as part of testing the system, each component of the system being tested may be checked by injecting faults into the respective components. Fault injection testing can be performed before the system being tested is deployed or used in a production environment. The fault injection system can also dynamically test a system by injecting faults while the system is running. In a test environment, the system being tested may be tested through multiple executions of the system being tested, with different faults being injected in different executions, locations, or the like.

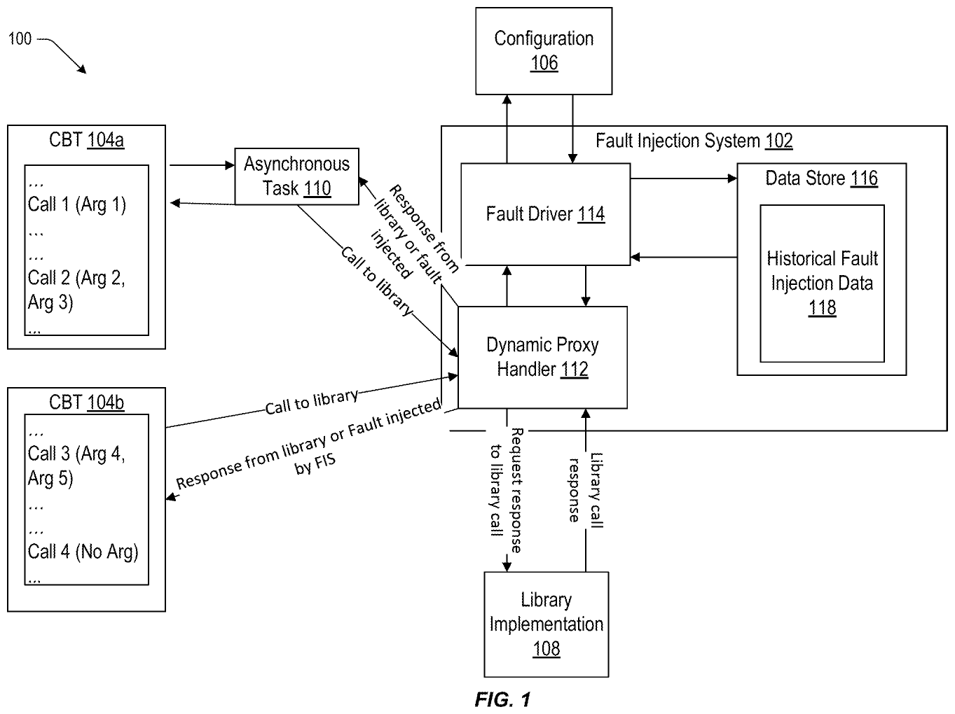

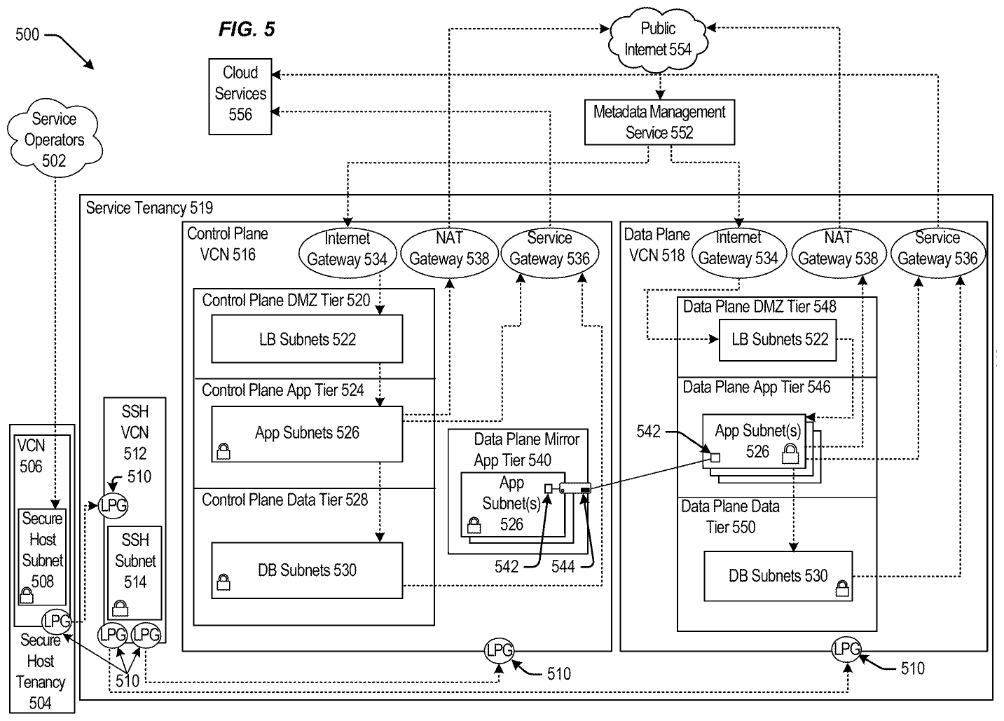

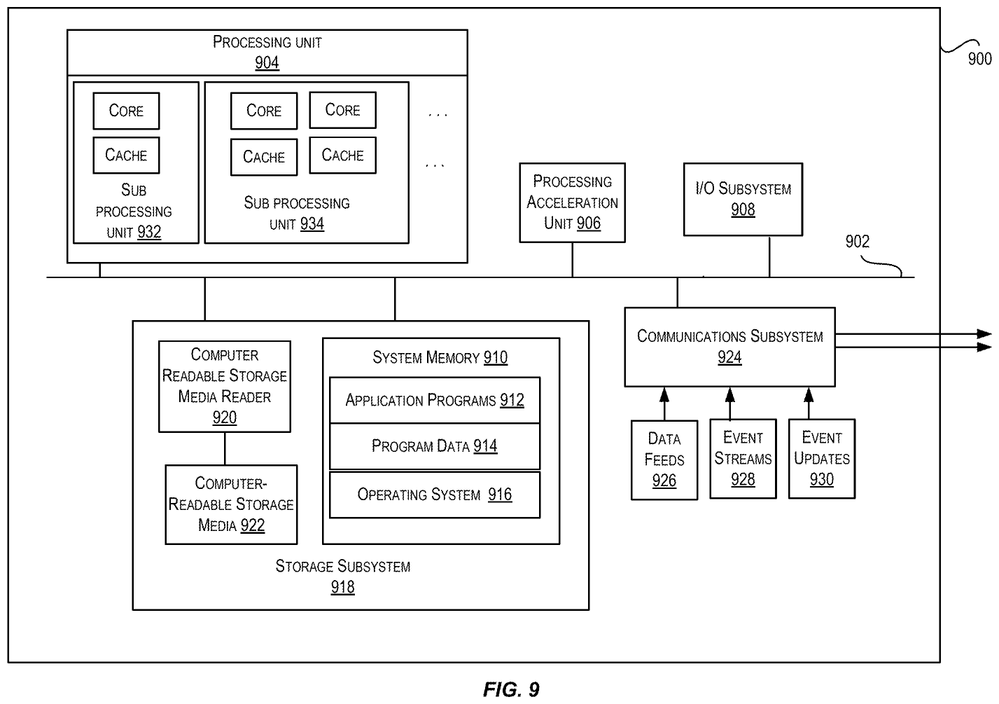

FIGS. 1-4 describe examples and embodiments related to a fault injection system that can be used to determine whether to inject a fault and to inject a fault in response to determining to inject the fault. FIGS. 5-8 depict examples of architectures for implementing cloud infrastructures for providing one or more cloud services, where the infrastructures may incorporate teachings described herein. FIG. 9 depicts a block diagram illustrating an example computer system or device, according to at least one embodiment.

### Novel Fault Injection Techniques Using Fault Injection System

FIG. 1 is a block diagram of a computing environment 100 including a fault injection system 102 that can be used to inject faults based on context information, according to at least one embodiment. As illustrated in FIG. 1, the computing environment 100 can include the fault injection system 102, one or more components being tested (CBT), such as a first CBT 104a and a second CBT 104b, a configuration 106, and a library implementation 108. Additional or alternative components, services, computing devices, and the like are possible for the computing environment 100.

Computing environment 100 depicted in FIG. 1 is merely an example and is not intended to unduly limit the scope of claimed embodiments. Many variations, alternatives, and modifications are possible. For example, in some implementations, computing environment 100 may have more or fewer systems or components than those shown in FIG. 1, may combine two or more systems, or may have a different configuration or arrangement of systems. The systems, subsystems, and other components depicted in FIG. 1 may be implemented in software (e.g., code, instructions, program) executed by one or more processing units (e.g., processors, cores) of the respective systems, using hardware, or combinations thereof. The software may be stored on a non-transitory storage medium (e.g., on a memory device).

In some examples, the first CBT 104a and the second CBT 104b may be process handlers that can be tested using fault injection. For example, the first CBT 104a and/or the second CBT 104b may be a piece of code implementing a process handle, one or more worker threads, or the like. Additionally or alternatively, the piece of code may be configured to implement a method, an application, a microservice, etc. In some embodiments, the first CBT 104a and/or the second CBT 104b can be worker threads, which accept and/or perform tasks. For example, in a REST-based application the first CBT 104a and/or the second CBT 104b can be threads performing some task at a controller layer after a REST endpoint is hit or a filter, which intercepts every request, is hit. In a workflow-based architecture, the first CBT 104a and/or the second CBT 104b can be threads executing a particular step of a particular workflow.

The first CBT 104a can be or include a first process handler, the second CBT 104b can be or include a second process handler, and so on. The first CBT 104a and/or the second CBT 104b may be configured to facilitate execution of tasks in the system environment. For example, the first CBT 104a and/or the second CBT 104b may be configured to generate and/or transmit a call to a library, such as the library implementation 108, to request a task (e.g., code execution) to be performed with respect to the system environment. In some examples, the first CBT 104a may make a call to, or may otherwise execute, an asynchronous task 110, which may in turn cause a call to be transmitted to cause the task to be executed. Additionally or alternatively, the second CBT 104b may make a call directly to the library or otherwise within the system environment to cause the task to be executed. In some embodiments, the first CBT 104a and/or the second CBT 104b can either perform a task in a same thread or can create and/or utilize another thread, such as the asynchronous task 110, to perform operations such as business logic, interaction with dependent services and the like. As illustrated, the first CBT 104a transfers the context to the asynchronous task 110, which is responsible for performing actual operations.

In some examples, each call generated and/or transmitted by the first CBT 104a and/or the second CBT 104b may include zero or more arguments passed with the call. As illustrated in FIG. 1, the first CBT 104a can generate and/or transmit a first call and a second call with one argument and two arguments, respectively. Additionally, as illustrated in FIG. 1, the second CBT 104b can generate and/or transmit a third call and a fourth call with two arguments and no arguments, respectively. Other suitable numbers (e.g., less than two or more than two) of calls are possible to be generated or transmitted by the first CBT 104a and/or the second CBT 104b. Additionally or alternatively, other suitable numbers (e.g., more than two) of arguments are possible to include in calls generated and/or transmitted by the first CBT 104a and/or the second CBT 104b. The calls originating, whether directly or indirectly, from the first CBT 104a and/or the second CBT 104b may be intercepted by the fault injection system 102.

In some embodiments the fault injection system 102 can include or use a dynamic proxy handler 112, a fault injection driver 114, a data store 116, and configuration information, which may originate from or otherwise be stored at the configuration 106. The dynamic proxy handler 112 may be or include a JAVA proxy or other suitable proxy handler that can intercept calls within the computing environment 100. For example, each call originating, whether directly or indirectly, from the first CBT 104a and/or the second CBT 104b may be intercepted by the dynamic proxy handler 112 to enable fault injection by the fault injection system 102. While illustrated as being included in the fault injection system 102, the dynamic proxy handler may, in some examples, be separate from and communicatively coupled with the fault injection system 102. In examples in which the dynamic proxy handler 112 is separate from the fault injection system 102, the dynamic proxy handler 112 may receive and/or intercept each call originating from the first CBT 104a and/or the second CBT 104b, and the dynamic proxy handler 112 may forward each intercepted call, and/or any information determined therefrom, to the fault injection system 102 to facilitate fault injection.

For a system being tested, such as an application or other system environment that may include the first CBT 104a and/or the second CBT 104b, on initialization of the system being tested, library dependencies can be injected in a container by registering through the dynamic proxy handler 112. Thus, any library call or module method call made by the first CBT 104a and/or the second CBT 104b can be intercepted via invocation of a process of the dynamic proxy handler 112. The dynamic proxy handler 112 can enable the fault injection system 102 to intercept and/or receive information about the call, the method, and/or a function called by the CBT, arguments provided to the call, related context information, and the like at any given time. The dynamic proxy handler 112 can call the fault injection driver 114 with the received information.

The dynamic proxy handler 112 can provide a mechanism for intercepting calls made by the first CBT 104a and/or the second CBT 104b. For each intercepted call, the dynamic proxy handler 112 can also receive or extract information related to the intercepted call. The information includes context information associated with the call. The dynamic proxy handler 112 can forward the context information to the fault injection driver 114. In some embodiments, and for an intercepted call, the dynamic proxy handler 112 can forward the following, which may be or include context information, to the fault injection driver 114:
information identifying the CBT (e.g., the first CBT 104a or the second CBT 104b) making the call;
fault point information or location information including information identifying the call and a code location where the call is made. In some examples, a fault point may refer to a code location where the CBT is using interface/library/clients to interact with dependent services in a certain code execution path in a workflow step;
information identifying an operation that caused the invocation of the call or that is otherwise associated with the call; and
arguments passed to the call invocation.

The dynamic proxy handler 112 can discover new fault points as the code implementing the first CBT 104a and/or the second CBT 104b evolves. For example, if the code of the first CBT 104a and/or the second CBT 104b is changed to add a new interaction point, such as a new call, the dynamic proxy handler 112 can automatically detect this new fault location and can subsequently facilitate injection of faults appropriately. The dynamic proxy handler 112 can parse the first CBT 104a and/or the second CBT 104b to identify locations within the first CBT 104a and/or the second CBT 104b of library calls, method calls, and the like. In some examples, each of the library calls, the method calls, and the like can represent a point in which the first CBT 104a and/or the second CBT 104b interacts with an external component. Additionally or alternatively, the call location within the first CBT 104a and/or the second CBT 104b can represent a fault point.

The fault injection driver 114 may be communicatively coupled with the dynamic proxy handler 112 and may be used to determine whether to inject a fault, a particular fault to inject, and the like. The fault injection driver 114 can receive an intercepted call from the dynamic proxy handler 112, can receive at least a portion of context information associated with the intercepted call from the dynamic proxy handler 112, and the like. The fault injection driver 114 can access the configuration 106, the data store 116, and the like to receive historical fault injection data 118, configuration data, and the like relating to the intercepted call. For example, the fault injection driver 114 can access the data store 116, which can store stateful information related to the component being tested and associated contextual faults testing information, to receive the historical fault injection data 118 to determine whether a fault has historically been injected for a combination of the first CBT 104a and/or the second CBT 104b and the intercepted call. Additionally or alternatively, the fault injection driver 114 can access the configuration 106 to determine and/or select a customized type of fault to inject and/or for other suitable purposes. In some examples, information accessed from the configuration 106 may be specific for the fault injection system 102 for controlling faults, such as at a CBT-level, a call-level, or at a call-context combination level, that are injected by the fault injection system 102.

The fault injection driver 114, which can receive context information from a running thread from the dynamic proxy handler 112, can use the context information to decide whether to inject a fault at the fault location. The fault injection driver 114 may decide whether to inject a fault based at least in part on the context information received from the dynamic proxy handler 112, state information (e.g., the historical fault injection data 118) stored by the fault injection system 102, configuration information (e.g., received from the configuration 106), and the like. The fault injection driver 114 can inject various different types of faults, including some default faults, such as latency, method exception, crash, etc., and customized faults that may be defined using the configuration information. The fault injection driver 114 can inject each type of fault, or any subset thereof, in a sequential manner, which can be changed for randomness. In some embodiments, the fault injection driver 114 may cycle through and inject default faults. For each run or execution of a particular CBT, the fault injection driver 114 can inject a single fault for each fault location, such as library call, interface call, etc., with different faults being injected for each execution, until all the default faults have been injected.

In some examples, a test engineer or other entity can use the configuration information to override one or more of the defaults faults. The override may be specified at the CBT-level or at particular fault locations within the first CBT 104a and/or the second CBT 104b. For example, the configuration information can be set using a library identifier and list of faults for a particular library. Thus, the configuration information may facilitate control of the faults that are injected by the fault injection system 102. The test engineer or other entity can also specify customized faults to be injected using the configuration information. The fault injection system 102 can inject the customized faults at various fault locations within the first CBT 104a and/or the second CBT 104b. The configuration information can enable control over the faults that are injected by the fault injection system 102 and also where, such as which CBT, which fault location within a CBT, or the like, the faults are injected.

The fault injection driver 114 can trigger faults based on one or more pre-defined conditions such as when a specific request, workflow, user, etc. is invoked. Upon determining that a fault is to be injected for a particular library call, the fault injection driver 114 can select a particular fault, for example from the configuration 106, to be injected, and the fault injection driver 114 can communicate the selected particular fault to the dynamic proxy handler 112. The dynamic proxy handler 112 can inject the fault into the first CBT 104a and/or the second CBT 104b by sending the particular fault as a response to the particular library call. Once the fault injection driver 114 has determined that a fault for a particular library call is to be injected, the dynamic proxy handler 112 may return the fault or failure to the first CBT 104a and/or the second CBT 104b. If the fault injection driver 114 determines to not return a fault and instead returns a success, the dynamic proxy handler 112 can delegate the call to the original or emulated library implementation, such as the library implementation 108, and can return the response from library to the first CBT 104a and/or the second CBT 104b.

If the fault injection driver 114 determines to not inject a fault for a particular fault location, such as because all the faults for that location have already been injected, etc., the library implementation of the call can be invoked with the arguments received from the dynamic proxy handler 112. In some embodiments, the dynamic proxy handler 112 can delegate the call to the original or emulated library implementation, such as the library implementation 108, and can return the response from the library to the first CBT 104a and/or the second CBT 104b. Thus, in multiple runs, the fault injection system 102 can test the resiliency of each of the first CBT 104a and the second CBT 104b and their interactions with each fault point with default and configured faults and properly execute code paths to identify potential issues.

In response to returning a fault, the fault injection driver 114 can update the state information, such as the historical fault injection data 118, stored for the first CBT 104a and/or the second CBT 104b to indicate the fault that has been injected for the particular call and the particular context associated with the call. For each call, or for each fault location within the first CBT 104a and/or the second CBT 104b, the state information can store information identifying a particular context associated with the call and information about the one or more faults that have been injected for that fault location and context combination. The state information can track the faults that have been injected for a combination of the fault location and a particular context. For example, there can be different contexts for the same fault location. Thus, the state information can store the fault history data for various CBTs, for various calls within each CBT and associated contexts. Using the state information, the fault injection system 102 can test the fault points encountered in different code execution path with all expected faults.

In some embodiments, the data store 116 can be a distributed database and/or cache in which the fault injection driver 114 can store the information of the first CBT 104a and/or the second CBT 104b (retrieved from context) along with fault point and injected fault. The fault injection driver 114 can retrieve the data from the data store 116 to determine whether a fault needs to be injected for a method call. The fault injection driver 114 can determine to ignore fault injection if the library/interface call is retried (this behavior can be overridden or extended) or application has successfully handled the previously injected fault to make sure testing goes faster and code path is clearly tested. In a next run the fault injection driver 114 can schedule a different fault for the same CBT and fault point by looking into fault history data stored in the data store 116.

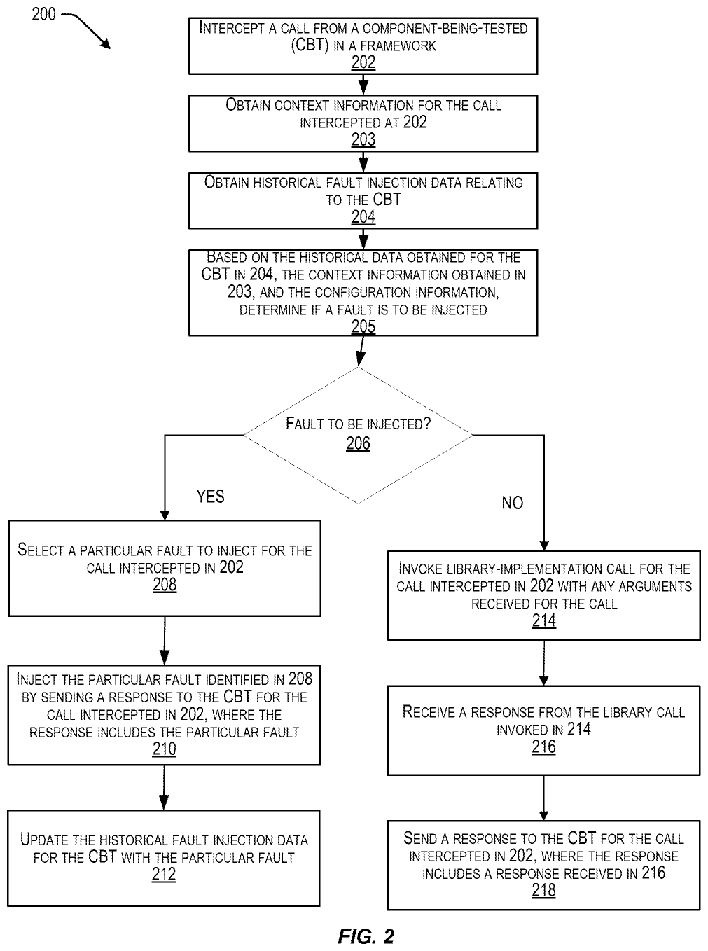

FIG. 2 is a flowchart of a process 200 to determine whether to inject a fault for a component being tested, according to at least one embodiment. The processing depicted in FIG. 2 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 2 and described below is intended to be illustrative and non-limiting. Although FIG. 2 depicts the various processing steps occurring in a particular sequence or order, this is not intended to be limiting. In certain alternative embodiments, the processing may be performed in some different order or some steps may also be performed in parallel. It should be appreciated that in alternative embodiments, the processing depicted in FIG. 2 may include a greater number or a lesser number of steps than those depicted in FIG. 2. In certain embodiments, such as in the embodiment depicted in FIG. 1, the processing depicted in FIG. 2 may be performed by the fault injection system 102.

At 202, the process 200 involves intercepting a call from a component being tested (CBT) in a fault injection system. The fault injection system may be or include a system environment, a system-being-tested, or the like, and, in some examples, the fault injection system may include one or more CBTs such as the first CBT 104a, the second CBT 104b, and the like. The one or more CBTs may generate and/or transmit a call within the system environment. For example, the one or more CBTs may generate and/or transmit a library call, a method call, or the like. The call can be intercepted by a fault injection system 102. For example, a dynamic proxy handler 112 of the fault injection system 102 can intercept the call.

At 203, the process 200 involves obtaining context information for the call intercepted at 202. The context information can include information identifying a fault location associated with the call and information identifying any arguments for the call. For example, the context information can identify a location within code that can be or include a location at which a fault would be injected, that is being called by the intercepted call, or the like. Additionally or alternatively, the context information identifies arguments for the call. For example, the arguments can be passed with (e.g., can be included in) the call, can be provided along with (e.g., separately from) the call, etc. The arguments can include zero arguments, one argument, two arguments, three arguments, or more than three arguments. Additionally or alternatively, the context information can identify a function or a workflow that caused the call to be invoked. The function or the workflow can be or include an overall process that includes the intercepted call, can be or include a reason for generating and/or transmitting the intercepted call, and the like. Additionally or alternatively, the context information can include an identity of the particular CBT that generated and/or transmitted the intercepted call, a configuration of the particular CBT that generated and/or transmitted the intercepted call, and the like.

In some examples, the dynamic proxy handler 112 can infer or otherwise determine the context information based upon the intercepted call. For example, the dynamic proxy handler 112 can intercept the call, and the dynamic proxy handler 112 can parse the call to identify metadata included in the call. The metadata may inform the dynamic proxy handler 112 of at least a portion of the context information. For example, the metadata of the intercepted call may indicate the identity of the particular CBT that generated and/or transmitted the intercepted call, may indicate the function or workflow that caused the call to be generated and/or transmitted, and the like. Additionally or alternatively, the dynamic proxy handler 112 can receive the one or more arguments with the intercepted call. Additionally or alternatively, the dynamic proxy handler 112 can infer, for example from the metadata or directly from the intercepted call, the fault location indicated by the intercepted call.

At 204, the process 200 involves obtaining historical fault injection data, such as the historical fault injection data 118, relating to the particular CBT. Based on the context information, which may indicate an identity of the particular CBT, particular historical fault injection data can be obtained. The historical fault injection data can include historical instances of fault injection for the particular CBT. The historical instances of fault injection can include indications of which faults have previously been injected for the particular CBT, indications of fault locations at which the previously injected faults have been injected, indications of context information for the previously injected faults, and the like. In some examples, obtaining historical fault injection data can include obtaining a set of combinations of fault data in which each combination of fault data included in the set of combinations of fault data includes an identification of a particular fault, an identification of a particular fault location into which the particular fault was injected, and an indication of context information associated with the particular fault.

In some examples, the fault injection driver 114 can obtain the historical fault injection data 118. For example, the dynamic proxy handler 112 can transmit the intercepted call and the context information for the intercepted call to the fault injection driver 114. The fault injection driver 114 can use the intercepted call and the context information to query the data store 116 for the historical fault injection data 118. For example, the fault injection driver 114 can determine an identity of the particular CBT and can generate and submit a query to the data store 116. The query can include a request for historical fault injection data relating to the particular CBT. The data store 116 can return the historical fault injection data 118 to the fault injection driver 114 in response to receiving the query.

At 206, the process 200 involves a determination of whether a fault is to be injected is performed. For example, the intercepted call, the context information, the historical fault injection data, and the like can be used to determine whether a fault is to be injected at the fault location indicated by the intercepted call and/or the context information. The determination may involve determining whether each potential type of fault has previously been injected for the particular CBT at the fault location. Additionally or alternatively, the determination may involve determining whether historical fault injections have been successful. If no faults have been injected at the fault location for the particular CBT, then it may be determined to inject a fault. Additionally or alternatively, if a particular type of fault has not yet been injected at the fault location for the particular CBT, then it may be determined to inject the particular type of fault. Additionally or alternatively, if each potential type of fault has previously been injected at the fault location for the particular CBT, then it may be determined to not inject a fault. In response to determining that a fault is to be injected, the process 200 proceeds to 208, and in response to determining that a fault is not to be injected, the process 200 proceeds to 214.

At 208, and in response to determining to inject a fault at the fault location for the particular CBT, the process 200 involves selecting a particular fault to inject for the call intercepted at 202. Selecting the particular fault may involve determining a fault that has not yet been injected at the fault location for the particular CBT. For example, the particular fault may be selected since the particular fault has not yet been injected. In some cases, more than one fault may not yet have been injected at the fault location for the particular CBT. In such cases, the selected particular fault may be randomly selected from the more than one fault, or the selected particular fault may have a higher score than other faults included in the more than one fault. The score may be determined based on an effectiveness of the corresponding fault, on user input for prioritizing the more than one fault, and the like.

At 210, the process 200 involves injecting the particular fault selected at 208. In some examples, injecting the selected fault may include sending a response to the particular CBT. The response may include the injected fault, which may intentionally cause an error for the particular CBT. In some examples, the injected fault may be the only item included in the response, and in other examples, the injected fault may be included in the response with at least a portion of a response received from a library call invoked via the intercepted call.

At 212, the process 200 involves updating the historical fault injection data for the particular CBT. Updating the historical fault injection data can include updating historical data stored at the data store 116. In some examples, an indication of whether the injected particular fault was successful may be recorded with the updated historical fault injection data. For example, a success may be recorded if the injected particular fault caused the intended fault in the particular CBT. Additionally or alternatively, a reaction of the particular CBT can be recorded with the updated historical fault injection data. For example, the reaction can be or include whether the CBT generated and/or corrected the injected fault, etc. In examples in which the injected particular fault was not successfully injected, the selected fault may be reinjected, the failed particular fault may be recorded with the updated fault injection data, or the like.

At 214, and in response to determining to not inject a fault at the fault location for the particular CBT, the process 200 involves invoking a library implementation for the call intercepted at 202. In examples in which the intercepted call includes or is otherwise configured to accept or otherwise use one or more arguments, invoking the library implementation for the call includes passing the one or more arguments with the library implementation of the call. Additionally or alternatively, invoking the library implementation of the call can include transmitting the intercepted call to a particular library to request a response to the intercepted call.

At 216, the process 200 involves receiving a library response in response to transmitting the library call in 214. The library response may be similar or identical to the library response received by the particular CBT if the originally submitted call from the particular CBT had not been intercepted. Additionally, at 218, the process 200 involves transmitting a response that includes the library response to the particular CBT. In some examples, the response that includes the library response may not include any injected faults.

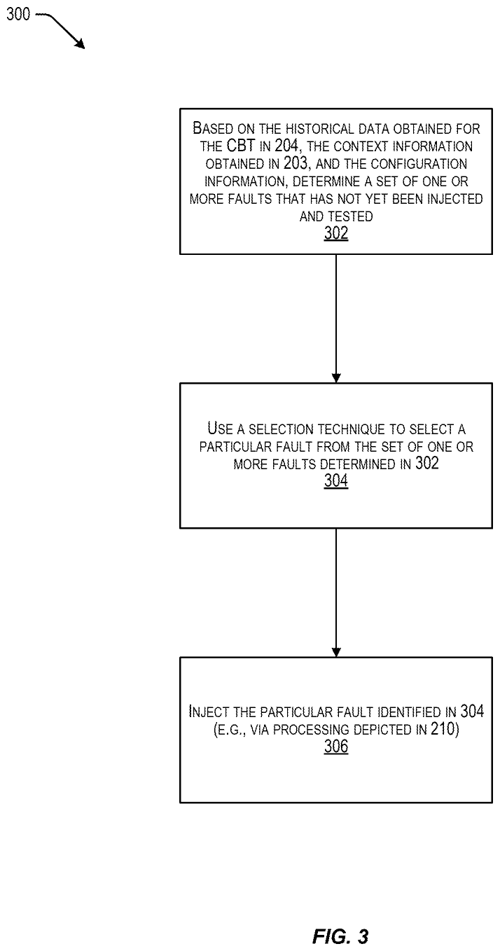

FIG. 3 is a flowchart of a process 300 to select and inject a particular fault, according to at least one embodiment. The processing depicted in FIG. 3 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 3 and described below is intended to be illustrative and non-limiting. Although FIG. 3 depicts the various processing steps occurring in a particular sequence or order, this is not intended to be limiting. In certain alternative embodiments, the processing may be performed in some different order or some steps may also be performed in parallel. It should be appreciated that in alternative embodiments, the processing depicted in FIG. 3 may include a greater number or a lesser number of steps than those depicted in FIG. 3. In certain embodiments, such as in the embodiment depicted in FIG. 1, the processing depicted in FIG. 3 may be performed by the fault injection system 102.

At 302, the process 300 involves determining a set of one or more faults that have not yet been injected and/or tested. The set of one or more faults may be determined based on an intercepted call such as the call intercepted in 202 of the process 200. Additionally or alternatively, the set of one or more faults may be determined based on context information associated with the intercepted call. In a particular example, the set of one or more faults can be determined for a particular CBT and may include any faults that have not yet have been injected at a fault location associated with the intercepted call and for the particular CBT. Historical fault injection data can be used to assist in determining the set of one or more faults. For example, faults indicated by the historical fault injection data as already having been injected may be excluded from the set of one or more faults, etc.

At 304, the process 300 involves using a selection technique to select a particular fault from the set of one or more faults. The selection technique may be determined by the fault injection system 102, may be determined by one or more components thereof, may be determined based upon user input, and the like. For example, the selection technique may be a random, or pseudo-random, selection process in which a random, or pseudo-random, fault is identified from the set of one or more faults, and the identified fault is selected based upon the selection technique. In another example, each fault included in the set of one or more faults can be ranked or otherwise scored. The ranking or scoring can be based upon a likelihood of the system environment encountering a real-world example of the corresponding fault, a level-of-disruption caused by a real world example of the corresponding fault, and the like. In such examples, the selection technique may involve selecting the particular fault based upon a highest, or a lowest, score among the set of one or more faults. In yet other examples, user input can be used to select the particular fault or to otherwise override an initial selection or recommendation of the selected fault.

At 306, the process 300 involves injecting the selected particular fault into the fault location for the particular CBT. In some examples, the selected particular fault can be injected based on processing described with respect to 210 of the process 200. For example, injecting the selected particular fault may include sending a response to the particular CBT. The response may include the injected fault, which may intentionally cause an error for the particular CBT. In some examples, the injected fault may be the only item included in the response, and in other examples, the injected fault may be included in the response with at least a portion of a response received from a library call invoked via the intercepted call.

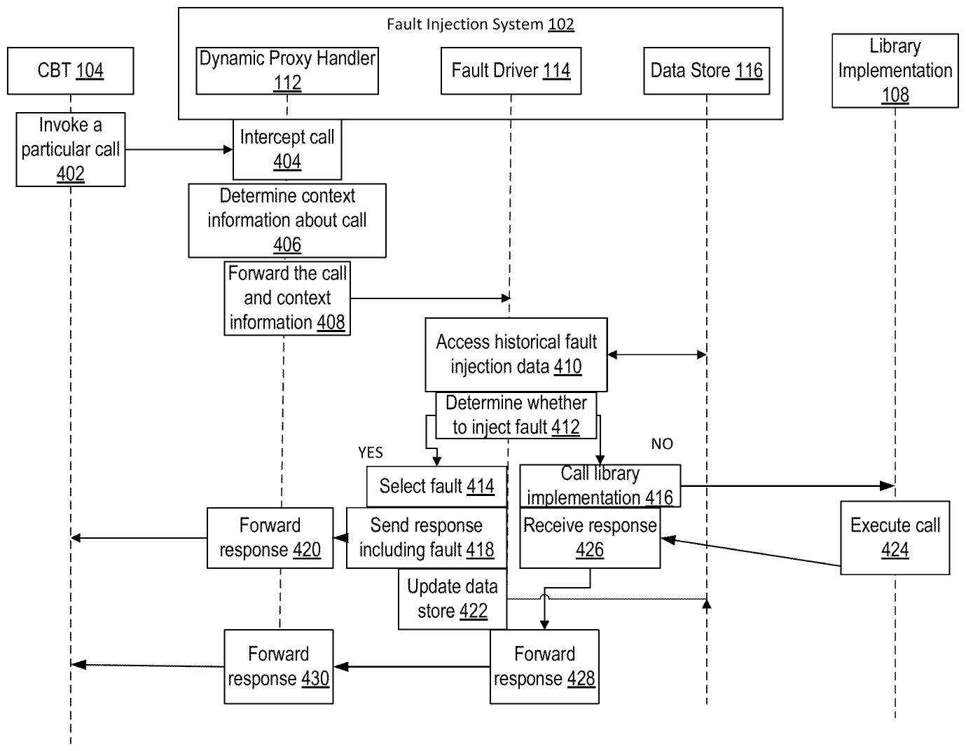

FIG. 4 is a swim-lane diagram 400 representing a process for determining whether to inject a fault for a component being tested, according to at least one embodiment. The swim-lane diagram 400 may involve a component being tested (e.g., the CBT 104), the fault injection system 102, and the library implementation 108, though other suitable components, computer systems, services, and the like may additionally or alternatively be included in the swim-lane diagram 400.

The swim-lane diagram 400 may begin with 402 in which the CBT 104 invokes a particular library call. The library call may include a request for a response from the library implementation 108. Additionally or alternatively, the library call may involve a request for performing one or more tasks, such as a REST operation, within a system environment that includes the CBT 104. At 404, the invoked library call is intercepted by the fault injection system 102. In some examples, the fault injection system 102 includes the dynamic proxy handler 112, is communicatively coupled with the dynamic proxy handler 112, or the like, and the dynamic proxy handler 112 can intercept the library call. At 406, the dynamic proxy handler 112 determines context information associated with the intercepted call. For example, the dynamic proxy handler 112 can parse the intercepted call to receive the context information, to infer the context information, or a combination thereof. For example, metadata included in the intercepted call may indicate at least a portion of the context information such as an identity of the CBT 104, a function or workflow that caused the library call to be invoked, and the like. Additionally or alternatively, at least a portion of the context information, such as any arguments included with the invoked call, etc., may be included in the intercepted call.

At 408, the dynamic proxy handler 112 forwards the intercepted call and the determined context information to a fault injection driver 114 that can be included in the fault injection system 102. At 410, the fault injection driver 114 can access historical fault injection data such as the historical fault injection data 118. The fault injection driver 114 can access a data store 116 that may be included in or otherwise be communicatively coupled with the fault injection system 102. The data store 116 may be configured to store historical fault injection data, which may be or include combinations of historically injected faults, historical fault locations into which the faults were injected, historical context information associated with the injected faults, and the like. At 412, the fault injection driver 114 determines whether to inject a fault at the fault location indicated by the intercepted call. The fault injection driver 114 can use the intercepted call, the context information, the historical fault injection data, and the like to determine whether to inject the fault at the fault location. For example, the fault injection driver 114 can identify whether at least one fault included in a configuration 106 has yet to be injected at the fault location for the CBT based at least in part upon the intercepted call, the context information, the historical fault injection data, and the like. Based on the determination made by the fault injection driver 114, the swim-lane diagram 400 can proceed to 414 or 416, for example in response to the fault injection driver 114 determining to inject the fault or to not inject the fault, respectively.

At 414, and in response to the fault injection driver 114 determining to inject a fault, the fault injection driver 114 selects a particular fault to inject. In some examples, the selection technique used by the fault injection driver can include a random or pseudo-random selection process, a rank-order selection process, a user-input-based selection process, or the like. For example, the fault injection driver 114 can randomly select a particular fault that has not yet been injected into the fault location for the CBT 104. At 418, the fault injection driver 114 generates and transmits a response to the dynamic proxy handler 112. The response includes the selected fault. In some examples, the response can include other items such as a library response to the intercepted call. Additionally or alternatively, the response may be designed to cause an error based on the selected fault. At 420, the dynamic proxy handler 112 forwards the response received from the fault injection driver 114 to the CBT 104. For example, the dynamic proxy handler 112 can transmit the response to the CBT 104 to cause the CBT 104 to encounter the injected fault. At 422, the fault injection driver 114 updates the data store 116 to reflect the injected fault. For example, the fault injection driver 114 can augment the historical fault injection data with the fault injected at 414.

At 416, and in response to the fault injection driver 114 determining to not inject a fault, the fault injection driver 114 calls the library implementation 108. For example, the fault injection driver 114 can include any arguments for the intercepted call and can forward the intercepted call to the library implementation 108 to request a library response on behalf of the CBT 104. At 424, the library implementation 108 executes the intercepted call. In some examples, executing the intercepted call can include generating the library response and/or performing one or more other tasks within the system environment. At 426, the fault injections driver 114 receives the library response from the library implementation 108. At 428, the fault injection driver 114 forwards the library response to the dynamic proxy handler 112, and at 430, the dynamic proxy handler 112 forwards the library response to the CBT 104. In such examples, the library response may exclude any faults.

In certain embodiments, the faults injection functionality described in this disclosure may be offered via a cloud service provided by a cloud service provider (CSP). For example, a CSP may offer a fault injection cloud service that can be subscribed to by one or more customers. For a customer subscribing to such a service, users associated with the subscribing customer can then use the cloud service to inject fault injection in systems to be tested. FIGS. 5-8 and the accompanying description provided below describe various examples of cloud architectures that may be used to implement such a cloud service.

### Examples of Architectures for Implementing Cloud Services

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed may need to be set up first. In some instances, the provisioning can be done manually, a provisioning tool may be utilized to provision the resources, and/or deployment tools may be utilized to deploy the code once the infrastructure is provisioned.

FIG. 5 is a block diagram 500 illustrating an example pattern of an IaaS architecture, according to at least one embodiment. Service operators 502 can be communicatively coupled to a secure host tenancy 504 that can include a virtual cloud network (VCN) 506 and a secure host subnet 508. In some examples, the service operators 502 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 506 and/or the Internet.

The VCN 506 can include a local peering gateway (LPG) 510 that can be communicatively coupled to a secure shell (SSH) VCN 512 via an LPG 510 contained in the SSH VCN 512. The SSH VCN 512 can include an SSH subnet 514, and the SSH VCN 512 can be communicatively coupled to a control plane VCN 516 via the LPG 510 contained in the control plane VCN 516. Also, the SSH VCN 512 can be communicatively coupled to a data plane VCN 518 via an LPG 510. The control plane VCN 516 and the data plane VCN 518 can be contained in a service tenancy 519 that can be owned and/or operated by the IaaS provider.

The control plane VCN 516 can include a control plane demilitarized zone (DMZ) tier 520 that acts as a perimeter network (e.g., portions of a corporate network between the corporate intranet and external networks). The DMZ-based servers may have restricted responsibilities and help keep breaches contained. Additionally, the DMZ tier 520 can include one or more load balancer (LB) subnet(s) 522, a control plane app tier 524 that can include app subnet(s) 526, a control plane data tier 528 that can include database (DB) subnet(s) 530 (e.g., frontend DB subnet(s) and/or backend DB subnet(s)). The LB subnet(s) 522 contained in the control plane DMZ tier 520 can be communicatively coupled to the app subnet(s) 526 contained in the control plane app tier 524 and an Internet gateway 534 that can be contained in the control plane VCN 516, and the app subnet(s) 526 can be communicatively coupled to the DB subnet(s) 530 contained in the control plane data tier 528 and a service gateway 536 and a network address translation (NAT) gateway 538. The control plane VCN 516 can include the service gateway 536 and the NAT gateway 538.

The control plane VCN 516 can include a data plane mirror app tier 540 that can include app subnet(s) 526. The app subnet(s) 526 contained in the data plane mirror app tier 540 can include a virtual network interface controller (VNIC) 542 that can execute a compute instance 544. The compute instance 544 can communicatively couple the app subnet(s) 526 of the data plane mirror app tier 540 to app subnet(s) 526 that can be contained in a data plane app tier 546.

The data plane VCN 518 can include the data plane app tier 546, a data plane DMZ tier 548, and a data plane data tier 550. The data plane DMZ tier 548 can include LB subnet(s) 522 that can be communicatively coupled to the app subnet(s) 526 of the data plane app tier 546 and the Internet gateway 534 of the data plane VCN 518. The app subnet(s) 526 can be communicatively coupled to the service gateway 536 of the data plane VCN 518 and the NAT gateway 538 of the data plane VCN 518. The data plane data tier 550 can also include the DB subnet(s) 530 that can be communicatively coupled to the app subnet(s) 526 of the data plane app tier 546.

The Internet gateway 534 of the control plane VCN 516 and of the data plane VCN 518 can be communicatively coupled to a metadata management service 552 that can be communicatively coupled to public Internet 554. Public Internet 554 can be communicatively coupled to the NAT gateway 538 of the control plane VCN 516 and of the data plane VCN 518. The service gateway 536 of the control plane VCN 516 and of the data plane VCN 518 can be communicatively coupled to cloud services 556.

In some examples, the service gateway 536 of the control plane VCN 516 or of the data plane VCN 518 can make application programming interface (API) calls to cloud services 556 without going through public Internet 554. The API calls to cloud services 556 from the service gateway 536 can be one-way: the service gateway 536 can make API calls to cloud services 556, and cloud services 556 can send requested data to the service gateway 536. But, cloud services 556 may not initiate API calls to the service gateway 536.

In some examples, the secure host tenancy 504 can be directly connected to the service tenancy 519, which may be otherwise isolated. The secure host subnet 508 can communicate with the SSH subnet 514 through an LPG 510 that may enable two-way communication over an otherwise isolated system. Connecting the secure host subnet 508 to the SSH subnet 514 may give the secure host subnet 508 access to other entities within the service tenancy 519.

The control plane VCN 516 may allow users of the service tenancy 519 to set up or otherwise provision desired resources. Desired resources provisioned in the control plane VCN 516 may be deployed or otherwise used in the data plane VCN 518. In some examples, the control plane VCN 516 can be isolated from the data plane VCN 518, and the data plane mirror app tier 540 of the control plane VCN 516 can communicate with the data plane app tier 546 of the data plane VCN 518 via VNICs 542 that can be contained in the data plane mirror app tier 540 and the data plane app tier 546.

In some examples, users of the system, or customers, can make requests, for example create, read, update, or delete (CRUD) operations, through public Internet 554 that can communicate the requests to the metadata management service 552. The metadata management service 552 can communicate the request to the control plane VCN 516 through the Internet gateway 534. The request can be received by the LB subnet(s) 522 contained in the control plane DMZ tier 520. The LB subnet(s) 522 may determine that the request is valid, and in response to this determination, the LB subnet(s) 522 can transmit the request to app subnet(s) 526 contained in the control plane app tier 524. If the request is validated and requires a call to public Internet 554, the call to public Internet 554 may be transmitted to the NAT gateway 538 that can make the call to public Internet 554. Metadata that may be desired to be stored by the request can be stored in the DB subnet(s) 530.

In some examples, the data plane mirror app tier 540 can facilitate direct communication between the control plane VCN 516 and the data plane VCN 518. For example, changes, updates, or other suitable modifications to configuration may be desired to be applied to the resources contained in the data plane VCN 518. Via a VNIC 542, the control plane VCN 516 can directly communicate with, and can thereby execute the changes, updates, or other suitable modifications to configuration to, resources contained in the data plane VCN 518.

In some embodiments, the control plane VCN 516 and the data plane VCN 518 can be contained in the service tenancy 519. In this case, the user, or the customer, of the system may not own or operate either the control plane VCN 516 or the data plane VCN 518. Instead, the IaaS provider may own or operate the control plane VCN 516 and the data plane VCN 518, both of which may be contained in the service tenancy 519. This embodiment can enable isolation of networks that may prevent users or customers from interacting with other users', or other customers', resources. Also, this embodiment may allow users or customers of the system to store databases privately without needing to rely on public Internet 554, which may not have a desired level of threat prevention, for storage.

In other embodiments, the LB subnet(s) 522 contained in the control plane VCN 516 can be configured to receive a signal from the service gateway 536. In this embodiment, the control plane VCN 516 and the data plane VCN 518 may be configured to be called by a customer of the IaaS provider without calling public Internet 554. Customers of the IaaS provider may desire this embodiment since database(s) that the customers use may be controlled by the IaaS provider and may be stored on the service tenancy 519, which may be isolated from public Internet 554.

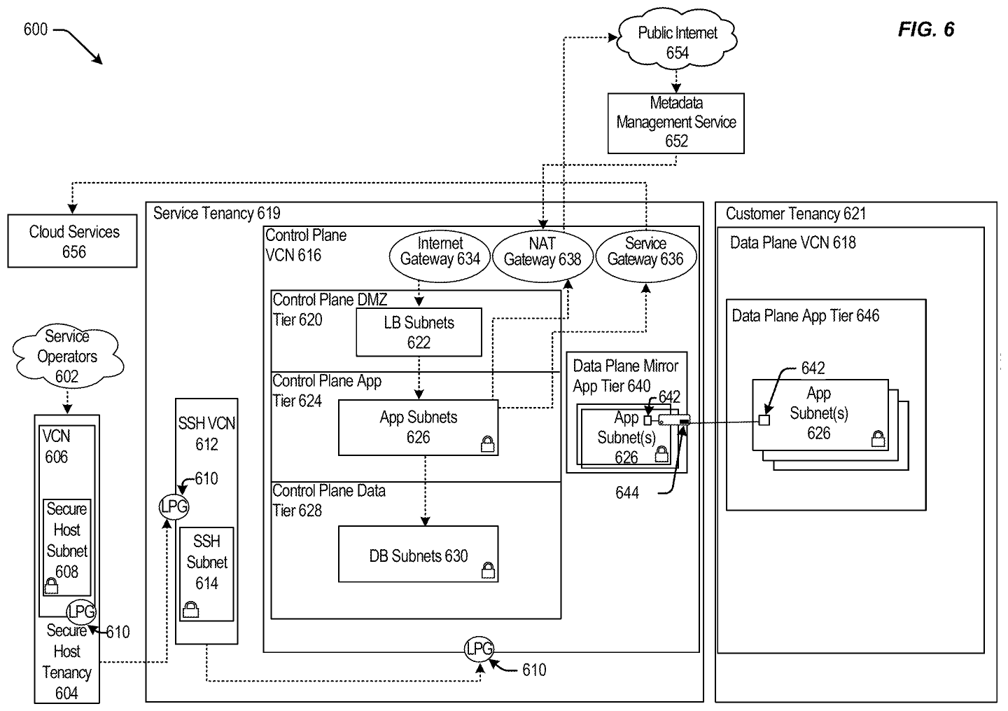

FIG. 6 is a block diagram 600 illustrating another example pattern of an IaaS architecture, according to at least one embodiment. Service operators 602 (e.g., service operators 502 of FIG. 5) can be communicatively coupled to a secure host tenancy 604 (e.g., the secure host tenancy 504 of FIG. 5) that can include a virtual cloud network (VCN) 606 (e.g., the VCN 506 of FIG. 5) and a secure host subnet 608 (e.g., the secure host subnet 508 of FIG. 5). The VCN 606 can include a local peering gateway (LPG) 610 (e.g., the LPG 510 of FIG. 5) that can be communicatively coupled to a secure shell (SSH) VCN 612 (e.g., the SSH VCN 512 of FIG. 5) via an LPG 510 contained in the SSH VCN 612. The SSH VCN 612 can include an SSH subnet 614 (e.g., the SSH subnet 514 of FIG. 5), and the SSH VCN 612 can be communicatively coupled to a control plane VCN 616 (e.g., the control plane VCN 516 of FIG. 5) via an LPG 610 contained in the control plane VCN 616. The control plane VCN 616 can be contained in a service tenancy 619 (e.g., the service tenancy 519 of FIG. 5), and the data plane VCN 618 (e.g., the data plane VCN 518 of FIG. 5) can be contained in a customer tenancy 621 that may be owned or operated by users, or customers, of the system.

The control plane VCN 616 can include a control plane DMZ tier 620 (e.g., the control plane DMZ tier 520 of FIG. 5) that can include LB subnet(s) 622 (e.g., LB subnet(s) 522 of FIG. 5), a control plane app tier 624 (e.g., the control plane app tier 524 of FIG. 5) that can include app subnet(s) 626 (e.g., app subnet(s) 526 of FIG. 5), a control plane data tier 628 (e.g., the control plane data tier 528 of FIG. 5) that can include database (DB) subnet(s) 630 (e.g., similar to DB subnet(s) 530 of FIG. 5). The LB subnet(s) 622 contained in the control plane DMZ tier 620 can be communicatively coupled to the app subnet(s) 626 contained in the control plane app tier 624 and an Internet gateway 634 (e.g., the Internet gateway 534 of FIG. 5) that can be contained in the control plane VCN 616, and the app subnet(s) 626 can be communicatively coupled to the DB subnet(s) 630 contained in the control plane data tier 628 and a service gateway 636 (e.g., the service gateway 536 of FIG. 5) and a network address translation (NAT) gateway 638 (e.g., the NAT gateway 538 of FIG. 5). The control plane VCN 616 can include the service gateway 636 and the NAT gateway 638.

The control plane VCN 616 can include a data plane mirror app tier 640 (e.g., the data plane mirror app tier 540 of FIG. 5) that can include app subnet(s) 626. The app subnet(s) 626 contained in the data plane mirror app tier 640 can include a virtual network interface controller (VNIC) 642 (e.g., the VNIC of 542) that can execute a compute instance 644 (e.g., similar to the compute instance 544 of FIG. 5). The compute instance 644 can facilitate communication between the app subnet(s) 626 of the data plane mirror app tier 640 and the app subnet(s) 626 that can be contained in a data plane app tier 646 (e.g., the data plane app tier 546 of FIG. 5) via the VNIC 642 contained in the data plane mirror app tier 640 and the VNIC 642 contained in the data plane app tier 646.

The Internet gateway 634 contained in the control plane VCN 616 can be communicatively coupled to a metadata management service 652 (e.g., the metadata management service 552 of FIG. 5) that can be communicatively coupled to public Internet 654 (e.g., public Internet 554 of FIG. 5). Public Internet 654 can be communicatively coupled to the NAT gateway 638 contained in the control plane VCN 616. The service gateway 636 contained in the control plane VCN 616 can be communicatively coupled to cloud services 656 (e.g., cloud services 556 of FIG. 5).

In some examples, the data plane VCN 618 can be contained in the customer tenancy 621. In this case, the IaaS provider may provide the control plane VCN 616 for each customer, and the IaaS provider may, for each customer, set up a unique compute instance 644 that is contained in the service tenancy 619. Each compute instance 644 may allow communication between the control plane VCN 616, contained in the service tenancy 619, and the data plane VCN 618 that is contained in the customer tenancy 621. The compute instance 644 may allow resources, that are provisioned in the control plane VCN 616 that is contained in the service tenancy 619, to be deployed or otherwise used in the data plane VCN 618 that is contained in the customer tenancy 621.

In other examples, the customer of the IaaS provider may have databases that live in the customer tenancy 621. In this example, the control plane VCN 616 can include the data plane mirror app tier 640 that can include app subnet(s) 626. The data plane mirror app tier 640 can reside in the data plane VCN 618, but the data plane mirror app tier 640 may not live in the data plane VCN 618. That is, the data plane mirror app tier 640 may have access to the customer tenancy 621, but the data plane mirror app tier 640 may not exist in the data plane VCN 618 or be owned or operated by the customer of the IaaS provider. The data plane mirror app tier 640 may be configured to make calls to the data plane VCN 618 but may not be configured to make calls to any entity contained in the control plane VCN 616. The customer may desire to deploy or otherwise use resources in the data plane VCN 618 that are provisioned in the control plane VCN 616, and the data plane mirror app tier 640 can facilitate the desired deployment, or other usage of resources, of the customer.

In some embodiments, the customer of the IaaS provider can apply filters to the data plane VCN 618. In this embodiment, the customer can determine what the data plane VCN 618 can access, and the customer may restrict access to public Internet 654 from the data plane VCN 618. The IaaS provider may not be able to apply filters or otherwise control access of the data plane VCN 618 to any outside networks or databases. Applying filters and controls by the customer onto the data plane VCN 618, contained in the customer tenancy 621, can help isolate the data plane VCN 618 from other customers and from public Internet 654.

In some embodiments, cloud services 656 can be called by the service gateway 636 to access services that may not exist on public Internet 654, on the control plane VCN 616, or on the data plane VCN 618. The connection between cloud services 656 and the control plane VCN 616 or the data plane VCN 618 may not be live or continuous. Cloud services 656 may exist on a different network owned or operated by the IaaS provider. Cloud services 656 may be configured to receive calls from the service gateway 636 and may be configured to not receive calls from public Internet 654. Some cloud services 656 may be isolated from other cloud services 656, and the control plane VCN 616 may be isolated from cloud services 656 that may not be in the same region as the control plane VCN 616. For example, the control plane VCN 616 may be located in “Region 1,” and cloud service “Deployment 5,” may be located in Region 1 and in “Region 2.” If a call to Deployment 5 is made by the service gateway 636 contained in the control plane VCN 616 located in Region 1, the call may be transmitted to Deployment 5 in Region 1. In this example, the control plane VCN 616, or Deployment 5 in Region 1, may not be communicatively coupled to, or otherwise in communication with, Deployment 5 in Region 2.

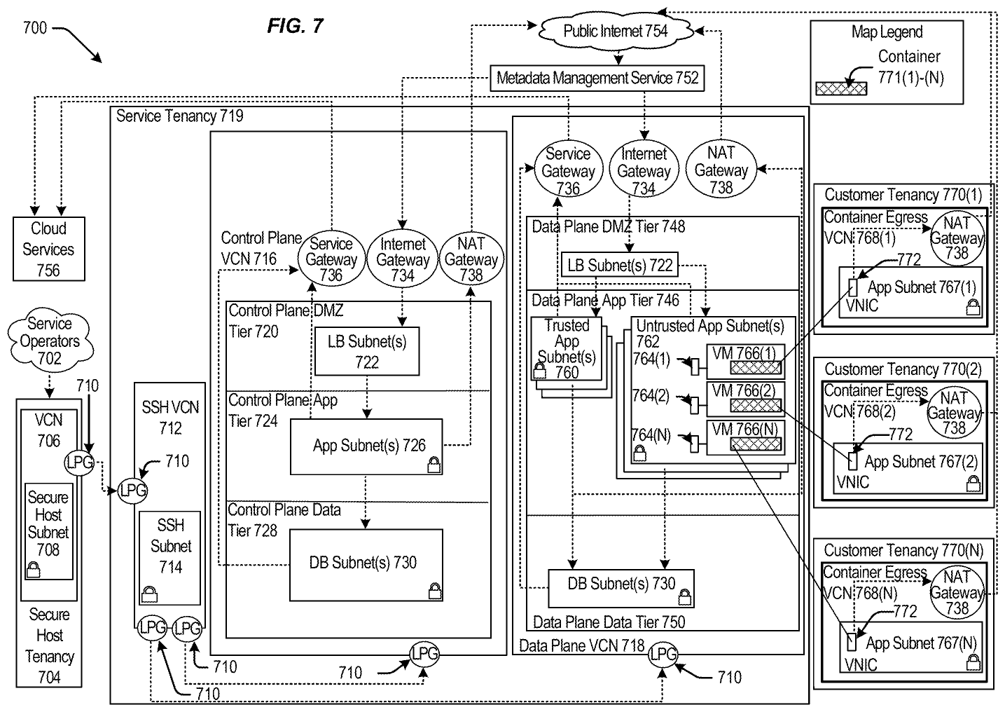

FIG. 7 is a block diagram 700 illustrating another example pattern of an IaaS architecture, according to at least one embodiment. Service operators 702 (e.g., service operators 502 of FIG. 5) can be communicatively coupled to a secure host tenancy 704 (e.g., the secure host tenancy 504 of FIG. 5) that can include a virtual cloud network (VCN) 706 (e.g., the VCN 506 of FIG. 5) and a secure host subnet 708 (e.g., the secure host subnet 508 of FIG. 5). The VCN 706 can include an LPG 710 (e.g., the LPG 510 of FIG. 5) that can be communicatively coupled to an SSH VCN 712 (e.g., the SSH VCN 512 of FIG. 5) via an LPG 710 contained in the SSH VCN 712. The SSH VCN 712 can include an SSH subnet 714 (e.g., the SSH subnet 514 of FIG. 5), and the SSH VCN 712 can be communicatively coupled to a control plane VCN 716 (e.g., the control plane VCN 516 of FIG. 5) via an LPG 710 contained in the control plane VCN 716 and to a data plane VCN 718 (e.g., the data plane 518 of FIG. 5) via an LPG 710 contained in the data plane VCN 718. The control plane VCN 716 and the data plane VCN 718 can be contained in a service tenancy 719 (e.g., the service tenancy 519 of FIG. 5).

The control plane VCN 716 can include a control plane DMZ tier 720 (e.g., the control plane DMZ tier 520 of FIG. 5) that can include load balancer (LB) subnet(s) 722 (e.g., LB subnet(s) 522 of FIG. 5), a control plane app tier 724 (e.g., the control plane app tier 524 of FIG. 5) that can include app subnet(s) 726 (e.g., similar to app subnet(s) 526 of FIG. 5), a control plane data tier 728 (e.g., the control plane data tier 528 of FIG. 5) that can include DB subnet(s) 730. The LB subnet(s) 722 contained in the control plane DMZ tier 720 can be communicatively coupled to the app subnet(s) 726 contained in the control plane app tier 724 and to an Internet gateway 734 (e.g., the Internet gateway 534 of FIG. 5) that can be contained in the control plane VCN 716, and the app subnet(s) 726 can be communicatively coupled to the DB subnet(s) 730 contained in the control plane data tier 728 and to a service gateway 736 (e.g., the service gateway of FIG. 5) and a network address translation (NAT) gateway 738 (e.g., the NAT gateway 538 of FIG. 5). The control plane VCN 716 can include the service gateway 736 and the NAT gateway 738.

The data plane VCN 718 can include a data plane app tier 746 (e.g., the data plane app tier 546 of FIG. 5), a data plane DMZ tier 748 (e.g., the data plane DMZ tier 548 of FIG. 5), and a data plane data tier 750 (e.g., the data plane data tier 550 of FIG. 5). The data plane DMZ tier 748 can include LB subnet(s) 722 that can be communicatively coupled to trusted app subnet(s) 760 and untrusted app subnet(s) 762 of the data plane app tier 746 and the Internet gateway 734 contained in the data plane VCN 718. The trusted app subnet(s) 760 can be communicatively coupled to the service gateway 736 contained in the data plane VCN 718, the NAT gateway 738 contained in the data plane VCN 718, and DB subnet(s) 730 contained in the data plane data tier 750. The untrusted app subnet(s) 762 can be communicatively coupled to the service gateway 736 contained in the data plane VCN 718 and DB subnet(s) 730 contained in the data plane data tier 750. The data plane data tier 750 can include DB subnet(s) 730 that can be communicatively coupled to the service gateway 736 contained in the data plane VCN 718.

The untrusted app subnet(s) 762 can include one or more primary VNICs 764(1)-(N) that can be communicatively coupled to tenant virtual machines (VMs) 766(1)-(N). Each tenant VM 766(1)-(N) can be communicatively coupled to a respective app subnet 767(1)-(N) that can be contained in respective container egress VCNs 768(1)-(N) that can be contained in respective customer tenancies 770(1)-(N). Respective secondary VNICs 772(1)-(N) can facilitate communication between the untrusted app subnet(s) 762 contained in the data plane VCN 718 and the app subnet contained in the container egress VCNs 768(1)-(N). Each container egress VCNs 768(1)-(N) can include a NAT gateway 738 that can be communicatively coupled to public Internet 754 (e.g., public Internet 554 of FIG. 5).

The Internet gateway 734 contained in the control plane VCN 716 and contained in the data plane VCN 718 can be communicatively coupled to a metadata management service 752 (e.g., the metadata management system 552 of FIG. 5) that can be communicatively coupled to public Internet 754. Public Internet 754 can be communicatively coupled to the NAT gateway 738 contained in the control plane VCN 716 and contained in the data plane VCN 718. The service gateway 736 contained in the control plane VCN 716 and contained in the data plane VCN 718 can be communicatively coupled to cloud services 756.

In some embodiments, the data plane VCN 718 can be integrated with customer tenancies 770. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 746. Code to run the function may be executed in the VMs 766(1)-(N), and the code may not be configured to run anywhere else on the data plane VCN 718. Each VM 766(1)-(N) may be connected to one customer tenancy 770. Respective containers 771(1)-(N) contained in the VMs 766(1)-(N) may be configured to run the code. In this case, there can be a dual isolation (e.g., the containers 771(1)-(N) running code, where the containers 771(1)-(N) may be contained in at least the VM 766(1)-(N) that are contained in the untrusted app subnet(s) 762), which may help prevent incorrect or otherwise undesirable code from damaging the network of the IaaS provider or from damaging a network of a different customer. The containers 771(1)-(N) may be communicatively coupled to the customer tenancy 770 and may be configured to transmit or receive data from the customer tenancy 770. The containers 771(1)-(N) may not be configured to transmit or receive data from any other entity in the data plane VCN 718. Upon completion of running the code, the IaaS provider may kill or otherwise dispose of the containers 771(1)-(N).

In some embodiments, the trusted app subnet(s) 760 may run code that may be owned or operated by the IaaS provider. In this embodiment, the trusted app subnet(s) 760 may be communicatively coupled to the DB subnet(s) 730 and be configured to execute CRUD operations in the DB subnet(s) 730. The untrusted app subnet(s) 762 may be communicatively coupled to the DB subnet(s) 730, but in this embodiment, the untrusted app subnet(s) may be configured to execute read operations in the DB subnet(s) 730. The containers 771(1)-(N) that can be contained in the VM 766(1)-(N) of each customer and that may run code from the customer may not be communicatively coupled with the DB subnet(s) 730.

In other embodiments, the control plane VCN 716 and the data plane VCN 718 may not be directly communicatively coupled. In this embodiment, there may be no direct communication between the control plane VCN 716 and the data plane VCN 718. However, communication can occur indirectly through at least one method. An LPG 710 may be established by the IaaS provider that can facilitate communication between the control plane VCN 716 and the data plane VCN 718. In another example, the control plane VCN 716 or the data plane VCN 718 can make a call to cloud services 756 via the service gateway 736. For example, a call to cloud services 756 from the control plane VCN 716 can include a request for a service that can communicate with the data plane VCN 718.

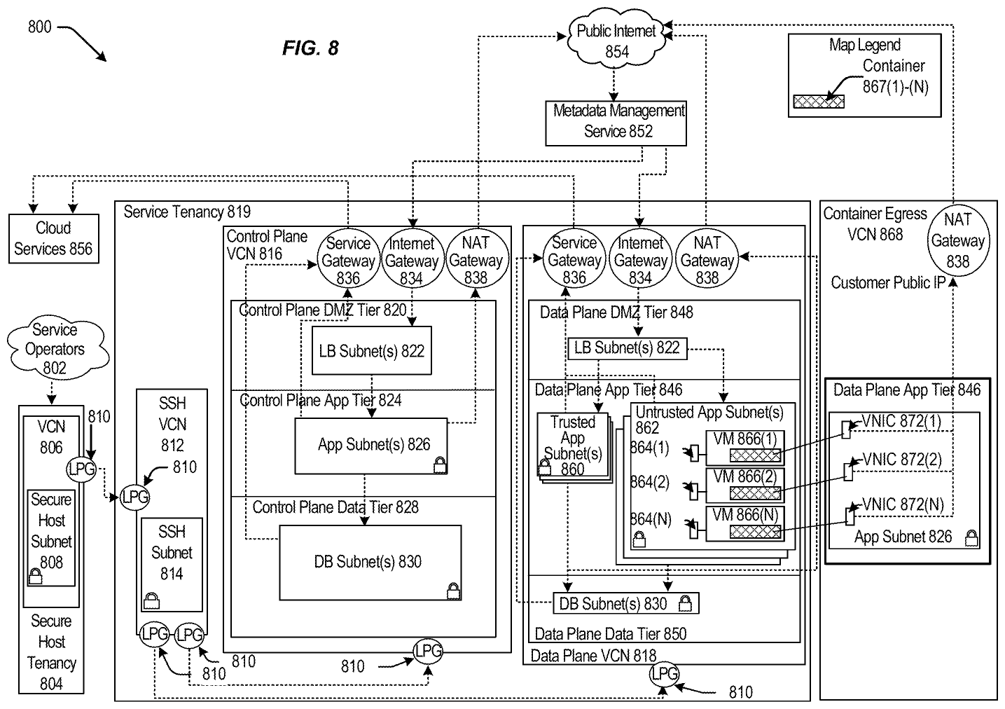

FIG. 8 is a block diagram 800 illustrating another example pattern of an IaaS architecture, according to at least one embodiment. Service operators 802 (e.g., service operators 502 of FIG. 5) can be communicatively coupled to a secure host tenancy 804 (e.g., the secure host tenancy 504 of FIG. 5) that can include a virtual cloud network (VCN) 806 (e.g., the VCN 506 of FIG. 5) and a secure host subnet 808 (e.g., the secure host subnet 508 of FIG. 5). The VCN 806 can include an LPG 810 (e.g., the LPG 510 of FIG. 5) that can be communicatively coupled to an SSH VCN 812 (e.g., the SSH VCN 512 of FIG. 5) via an LPG 810 contained in the SSH VCN 812. The SSH VCN 812 can include an SSH subnet 814 (e.g., the SSH subnet 514 of FIG. 5), and the SSH VCN 812 can be communicatively coupled to a control plane VCN 816 (e.g., the control plane VCN 516 of FIG. 5) via an LPG 810 contained in the control plane VCN 816 and to a data plane VCN 818 (e.g., the data plane 518 of FIG. 5) via an LPG 810 contained in the data plane VCN 818. The control plane VCN 816 and the data plane VCN 818 can be contained in a service tenancy 819 (e.g., the service tenancy 519 of FIG. 5).

The control plane VCN 816 can include a control plane DMZ tier 820 (e.g., the control plane DMZ tier 520 of FIG. 5) that can include LB subnet(s) 822 (e.g., LB subnet(s) 522 of FIG. 5), a control plane app tier 824 (e.g., the control plane app tier 524 of FIG. 5) that can include app subnet(s) 826 (e.g., app subnet(s) 526 of FIG. 5), a control plane data tier 828 (e.g., the control plane data tier 528 of FIG. 5) that can include DB subnet(s) 830 (e.g., DB subnet(s) 730 of FIG. 7). The LB subnet(s) 822 contained in the control plane DMZ tier 820 can be communicatively coupled to the app subnet(s) 826 contained in the control plane app tier 824 and to an Internet gateway 834 (e.g., the Internet gateway 534 of FIG. 5) that can be contained in the control plane VCN 816, and the app subnet(s) 826 can be communicatively coupled to the DB subnet(s) 830 contained in the control plane data tier 828 and to a service gateway 836 (e.g., the service gateway of FIG. 5) and a network address translation (NAT) gateway 838 (e.g., the NAT gateway 538 of FIG. 5). The control plane VCN 816 can include the service gateway 836 and the NAT gateway 838.

The data plane VCN 818 can include a data plane app tier 846 (e.g., the data plane app tier 546 of FIG. 5), a data plane DMZ tier 848 (e.g., the data plane DMZ tier 548 of FIG. 5), and a data plane data tier 850 (e.g., the data plane data tier 550 of FIG. 5). The data plane DMZ tier 848 can include LB subnet(s) 822 that can be communicatively coupled to trusted app subnet(s) 860 (e.g., trusted app subnet(s) 760 of FIG. 7) and untrusted app subnet(s) 862 (e.g., untrusted app subnet(s) 762 of FIG. 7) of the data plane app tier 846 and the Internet gateway 834 contained in the data plane VCN 818. The trusted app subnet(s) 860 can be communicatively coupled to the service gateway 836 contained in the data plane VCN 818, the NAT gateway 838 contained in the data plane VCN 818, and DB subnet(s) 830 contained in the data plane data tier 850. The untrusted app subnet(s) 862 can be communicatively coupled to the service gateway 836 contained in the data plane VCN 818 and DB subnet(s) 830 contained in the data plane data tier 850. The data plane data tier 850 can include DB subnet(s) 830 that can be communicatively coupled to the service gateway 836 contained in the data plane VCN 818.

The untrusted app subnet(s) 862 can include primary VNICs 864(1)-(N) that can be communicatively coupled to tenant virtual machines (VMs) 866(1)-(N) residing within the untrusted app subnet(s) 862. Each tenant VM 866(1)-(N) can run code in a respective container 867(1)-(N), and be communicatively coupled to an app subnet 826 that can be contained in a data plane app tier 846 that can be contained in a container egress VCN 868. Respective secondary VNICs 872(1)-(N) can facilitate communication between the untrusted app subnet(s) 862 contained in the data plane VCN 818 and the app subnet contained in the container egress VCN 868. The container egress VCN can include a NAT gateway 838 that can be communicatively coupled to public Internet 854 (e.g., public Internet 554 of FIG. 5).

The Internet gateway 834 contained in the control plane VCN 816 and contained in the data plane VCN 818 can be communicatively coupled to a metadata management service 852 (e.g., the metadata management system 552 of FIG. 5) that can be communicatively coupled to public Internet 854. Public Internet 854 can be communicatively coupled to the NAT gateway 838 contained in the control plane VCN 816 and contained in the data plane VCN 818. The service gateway 836 contained in the control plane VCN 816 and contained in the data plane VCN 818 can be communicatively coupled to cloud services 856.

In some examples, the pattern illustrated by the architecture of block diagram 800 of FIG. 8 may be considered an exception to the pattern illustrated by the architecture of block diagram 700 of FIG. 7 and may be desirable for a customer of the IaaS provider if the IaaS provider cannot directly communicate with the customer (e.g., a disconnected region). The respective containers 867(1)-(N) that are contained in the VMs 866(1)-(N) for each customer can be accessed in real-time by the customer. The containers 867(1)-(N) may be configured to make calls to respective secondary VNICs 872(1)-(N) contained in app subnet(s) 826 of the data plane app tier 846 that can be contained in the container egress VCN 868. The secondary VNICs 872(1)-(N) can transmit the calls to the NAT gateway 838 that may transmit the calls to public Internet 854. In this example, the containers 867(1)-(N) that can be accessed in real-time by the customer can be isolated from the control plane VCN 816 and can be isolated from other entities contained in the data plane VCN 818. The containers 867(1)-(N) may also be isolated from resources from other customers.

In other examples, the customer can use the containers 867(1)-(N) to call cloud services 856. In this example, the customer may run code in the containers 867(1)-(N) that requests a service from cloud services 856. The containers 867(1)-(N) can transmit this request to the secondary VNICs 872(1)-(N) that can transmit the request to the NAT gateway that can transmit the request to public Internet 854. Public Internet 854 can transmit the request to LB subnet(s) 822 contained in the control plane VCN 816 via the Internet gateway 834. In response to determining the request is valid, the LB subnet(s) can transmit the request to app subnet(s) 826 that can transmit the request to cloud services 856 via the service gateway 836.

It should be appreciated that IaaS architectures 500, 600, 700, 800 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

### Example of a Computer System or Device

FIG. 9 illustrates an example computer system 900 that may be used to implement various embodiments described in this disclosure. The system 900 may be used to implement any of the computer systems described above. As shown in the figure, computer system 900 includes a processing unit 904 that communicates with a number of peripheral subsystems via a bus subsystem 902. These peripheral subsystems may include a processing acceleration unit 906, an I/O subsystem 908, a storage subsystem 918 and a communications subsystem 924. Storage subsystem 918 includes tangible computer-readable storage media 922 and a system memory 910.

Bus subsystem 902 provides a mechanism for letting the various components and subsystems of computer system 900 communicate with each other as intended. Although bus subsystem 902 is shown schematically as a single bus, alternative embodiments of the bus subsystem may utilize multiple buses. Bus subsystem 902 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 904, which can be implemented as one or more integrated circuits (e.g., a conventional microprocessor or microcontroller), controls the operation of computer system 900. One or more processors may be included in processing unit 904. These processors may include single core or multicore processors. In certain embodiments, processing unit 904 may be implemented as one or more independent processing units 932 and/or 934 with single or multicore processors included in each processing unit. In other embodiments, processing unit 904 may also be implemented as a quad-core processing unit formed by integrating two dual-core processors into a single chip.

In various embodiments, processing unit 904 can execute a variety of programs in response to program code and can maintain multiple concurrently executing programs or processes. At any given time, some or all of the program code to be executed can be resident in processor(s) 904 and/or in storage subsystem 918. Through suitable programming, processor(s) 904 can provide various functionalities described above. Computer system 900 may additionally include a processing acceleration unit 906, which can include a digital signal processor (DSP), a special-purpose processor, and/or the like.

I/O subsystem 908 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 900 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 900 may comprise a storage subsystem 918 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 904 provide the functionality described above. Storage subsystem 918 may also provide a repository for storing data used in accordance with the present disclosure.

As depicted in the example in FIG. 9, storage subsystem 918 can include various components including a system memory 910, computer-readable storage media 922, and a computer readable storage media reader 920. System memory 910 may store program instructions that are loadable and executable by processing unit 904. System memory 910 may also store data that is used during the execution of the instructions and/or data that is generated during the execution of the program instructions. Various different kinds of programs may be loaded into system memory 910 including but not limited to client applications, Web browsers, mid-tier applications, relational database management systems (RDBMS), virtual machines, containers, etc.

System memory 910 may also store an operating system 916. Examples of operating system 916 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 900 executes one or more virtual machines, the virtual machines along with their guest operating systems (GOSs) may be loaded into system memory 910 and executed by one or more processors or cores of processing unit 904.

System memory 910 can come in different configurations depending upon the type of computer system 900. For example, system memory 910 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 910 may include a basic input/output system (BIOS) containing basic routines that help to transfer information between elements within computer system 900, such as during start-up.

Computer-readable storage media 922 may represent remote, local, fixed, and/or removable storage devices plus storage media for temporarily and/or more permanently containing, storing, computer-readable information for use by computer system 900 including instructions executable by processing unit 904 of computer system 900.

Computer-readable storage media 922 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 922 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 922 may include, but is not limited to, Zip® drives, flash memory cards, universal serial bus (USB) flash drives, secure digital (SD) cards, DVD disks, digital video tape, and the like. Computer-readable storage media 922 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 900.

Machine-readable instructions executable by one or more processors or cores of processing unit 904 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 924 provides an interface to other computer systems and networks. Communications subsystem 924 serves as an interface for receiving data from and transmitting data to other systems from computer system 900. For example, communications subsystem 924 may enable computer system 900 to connect to one or more devices via the Internet. In some embodiments communications subsystem 924 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 924 can provide wired network connectivity (e.g., Ethernet) in addition to or instead of a wireless interface.

In some embodiments, communications subsystem 924 may also receive input communication in the form of structured and/or unstructured data feeds 926, event streams 928, event updates 930, and the like on behalf of one or more users who may use computer system 900.

By way of example, communications subsystem 924 may be configured to receive data feeds 926 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 924 may also be configured to receive data in the form of continuous data streams, which may include event streams 928 of real-time events and/or event updates 930, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 924 may also be configured to output the structured and/or unstructured data feeds 926, event streams 928, event updates 930, and the like to one or more databases that may be in communication with one or more streaming data source computers coupled to computer system 900.

Computer system 900 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 900 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method, comprising:
intercepting a call invoked by a component-being-tested (CBT);
determining context information for the call, the context information comprising information identifying a fault location associated with the call and information identifying any arguments for the call;
performing processing to determine whether to inject a fault at the fault location associated with the call, the processing comprising, based on historical fault injection data stored for the CBT and the context information determined for the call, determining if a fault is to be injected for the call, wherein the historical fault injection data stored for the CBT includes data for previously injected faults for the CBT and historical context information for the previously injected faults;
in response to determining that a fault is to be injected, identifying a particular fault to be injected and injecting the particular fault at the fault location during execution of the CBT; and
in response to determining that a fault is not to be injected, invoking a library implementation corresponding to the call.

2. The method of claim 1, wherein the context information identifies a function or a workflow that caused the call to be invoked.

3. The method of claim 1, wherein:
performing processing to determine whether to inject the fault comprises selecting a particular fault to be injected based upon the historical fault injection data for a combination of the call and associated particular context; and
injecting the fault at the fault location during execution of the CBT comprises injecting the selected particular fault into the CBT by providing the selected particular fault to the CBT as a response to the call.

4. The method of claim 3, wherein selecting the particular fault comprises:
determining, based upon the historical fault injection data, a particular type of fault that has not been previously injected for the combination; and
selecting the particular fault for injection to be of the particular type of fault.

5. The method of claim 3, wherein selecting the particular fault comprises selecting a default fault type or a customized fault type, and wherein the customized fault type is specified using configuration information provided to a computing system.

6. The method of claim 5, wherein:
intercepting the call from the CBT is performed by a dynamic proxy handler of the computing system that is configured to intercept the call, obtain the context information, and inject the selected particular fault into the CBT; and
determining whether the fault is to be injected is performed by a fault driver of the computing system that is configured to select the particular fault for injection into the CBT.

7. The method of claim 1, wherein determining whether the fault is to be injected comprises determining whether to inject multiple faults sequentially or at least partially in parallel.

8. A system comprising:
one or more processors; and
a memory coupled to the one or more processors, the memory storing a plurality of instructions executable by the one or more processors, the plurality of instructions comprising instructions executable by the one or more processors to cause the one or more processors to perform operations comprising:
intercepting a call invoked by a component-being-tested (CBT);
determining context information for the call, the context information comprising information identifying a fault location associated with the call and information identifying any arguments for the call;
performing processing to determine whether to inject a fault at the fault location associated with the call, the processing comprising, based on historical fault injection data stored for the CBT and the context information determined for the call, determining if a fault is to be injected for the call, wherein the historical fault injection data stored for the CBT includes data for previously injected faults for the CBT and historical context information for the previously injected faults;
in response to determining that a fault is to be injected, identifying a particular fault to be injected and injecting the particular fault at the fault location during execution of the CBT; and
in response to determining that a fault is not to be injected, invoking a library implementation corresponding to the call.

9. The system of claim 8, wherein the context information identifies a function or a workflow that caused the call to be invoked.

10. The system of claim 8, wherein:
the operation of performing processing to determine whether to inject the fault comprises selecting a particular fault to be injected based upon the historical fault injection data for a combination of the call and associated particular context; and
the operation of injecting the fault at the fault location during execution of the CBT comprises injecting the selected particular fault into the CBT by providing the selected particular fault to the CBT as a response to the call.

11. The system of claim 10, wherein the operation of selecting the particular fault comprises:
determining, based upon the historical fault injection data, a particular type of fault that has not been previously injected for the combination; and
selecting the particular fault for injection to be of the particular type of fault.

12. The system of claim 10, wherein the operation of selecting the particular fault comprises selecting a default fault type or a customized fault type, and wherein the customized fault type is specified using configuration information provided to a computing system.

13. The system of claim 12, further comprising a dynamic proxy handler and a fault driver, wherein:
the operation of intercepting the call from the CBT is performed by a dynamic proxy handler of the computing system that is configured to intercept the call, obtain the context information, and inject the selected particular fault into the CBT; and
the operation of determining whether the fault is to be injected is performed by a fault driver of the computing system that is configured to select the particular fault for injection into the CBT.

14. The system of claim 8, wherein the operation of determining whether the fault is to be injected comprises determining whether to inject multiple faults sequentially or at least partially in parallel.

15. A non-transitory computer-readable memory storing a plurality of instructions executable by one or more processors, the plurality of instructions comprising instructions that when executed by the one or more processors cause the one or more processors to perform operations, comprising:
intercepting a call invoked by a component-being-tested (CBT);
determining context information for the call, the context information comprising information identifying a fault location associated with the call and information identifying any arguments for the call;
performing processing to determine whether to inject a fault at the fault location associated with the call, the processing comprising, based on historical fault injection data stored for the CBT and the context information determined for the call, determining if a fault is to be injected for the call, wherein the historical fault injection data stored for the CBT includes data for previously injected faults for the CBT and historical context information for the previously injected faults;
in response to determining that a fault is to be injected, identifying a particular fault to be injected and injecting the particular fault at the fault location during execution of the CBT; and
in response to determining that a fault is not to be injected, invoking a library implementation corresponding to the call.

16. The non-transitory computer-readable memory of claim 15, wherein the context information identifies a function or a workflow that caused the call to be invoked.

17. The non-transitory computer-readable memory of claim 15, wherein:
the operation of performing processing to determine whether to inject the fault comprises selecting a particular fault to be injected based upon the historical fault injection data for a combination of the call and associated particular context; and
the operation of injecting the fault at the fault location during execution of the CBT comprises injecting the selected particular fault into the CBT by providing the selected particular fault to the CBT as a response to the call.

18. The non-transitory computer-readable memory of claim 17, wherein the operation of selecting the particular fault comprises:
determining, based upon the historical fault injection data, a particular type of fault that has not been previously injected for the combination; and
selecting the particular fault for injection to be of the particular type of fault.

19. The non-transitory computer-readable memory of claim 17, wherein the operation of selecting the particular fault comprises selecting a default fault type or a customized fault type, and wherein the customized fault type is specified using configuration information provided to a computing system.

20. The non-transitory computer-readable memory of claim 19, wherein the configuration information is specific for a fault injection system for controlling faults, either at a CBT-level, a call-level, or at a call-context combination level, that are injected by the fault injection system.
